(19) United States
(12) Patent Application Publication
(10) Pub. No.: US 2012/0259751 A1
(43) Pub. Date: Oct. 11, 2012

(54) Escrow Accommodation method and system

(76) Inventor: Ruben G. Duran, Montebello, CA (US)

(21) Appl. No.: 12/658,673

(22) Filed: Feb. 12, 2010

Related U.S. Application Data
(63) Continuation-in-part of application No. 09/916,927, filed on Jul. 27, 2001, now Pat. No. 8,140,430.

(51) Int. Cl. G06Q 40/00; G06Q 10/00; H04N 7/15; G06Q 99/00

(52) U.S. Cl. 705/35; 705/310; 348/14.08; 348/E07.083

(57) ABSTRACT

An escrow accommodation method and system adapted for deployment via the offices of brokers, mortgage companies, lending institutions and title insurers to facilitate remote video-conferencing of potential buyers and sellers with independent escrow agents. The design includes contracting with and/or contacting at least one escrow company to provide escrow services from a remote location; contracting with and/or contacting at least one non-escrow company, e.g., broker, mortgage company, lending institution, and/or title insurer, to allow remote escrow services to be provided at an office of at least one non-escrow company; and enabling the provision of escrow services by the escrow company to an individual located at the office of at least one non-escrow company via a videoconferencing system disposed between the escrow company and the office of the non-escrow company.

The present application is a continuation-in-part of co-pending U.S. patent application Ser. No. 09/916,927, entitled “Escrow Accommodation System,” inventor Ruben Duran, filed Jul. 27, 2001, the entirety of which is incorporated herein by reference.

### BACKGROUND OF THE INVENTION

1. Field of the Invention

The present invention relates to methods and systems for facilitating escrow transactions.

2. Description of the Related Art

Conventionally, escrow services have been provided by independent escrow companies. However, more recently, real estate brokers, title insurance companies, and others have begun to offer escrow services for the convenience of their customers and to generate supplemental income. Unfortunately, these ‘secondary’ escrow service providers must bear significant costs to provide escrow services.

As described in “Escrow”, Microsoft Encarta, Encyclopedia 2000, an escrow, in law, is a conditional delivery of money, property or documents, evidencing or transferring rights therein, to a third party to be kept by that party until certain conditions are satisfied and then to be delivered over to an oblige or grantee. The property or documents thus conditionally held are also called the “escrow” and the contract defining the conditions of the second delivery is called the ‘escrow agreement or escrow instructions’.

An escrow is a device most frequently utilized in real-estate transactions. A deed, for example, delivered in escrow does not operate as an obligation or conveyance so long as it remains in the hands of the third person. When the prescribed conditions are fulfilled, the deed generally takes effect from the second delivery.

Those who have purchased or refinanced a home can appreciate the amount of labor involved in the escrow process. Thus the provision of onsite escrow services by a secondary escrow company typically requires various expenditures, including but not limited to a salary with benefits for the escrow officer, an office, phone and fax services, advertising expenses, and so forth. Consequently, the supplemental income due to the provision of onsite escrow services is currently often marginal.

In addition, prospective buyers and sellers do not currently have an opportunity to shop among alternate escrow companies. Instead, one escrow agent is typically recommended by a broker and accepted by the parties without further consideration. Consequently, the costs and the quality of the escrow services provided to the would-be buyers and sellers may be less than optimal.

For these and other reasons, a need exists in the art for a method for improving the availability and accessibility of independent escrow services. More specifically, a need exists in the art for a method for reducing the costs associated with onsite escrow services borne by secondary escrow service providers while increasing the options of buyers and sellers with respect to providers of escrow services.

### SUMMARY OF THE INVENTION

According to one aspect of the present design, there is provided an escrow accommodation method and system adapted for deployment via the offices of brokers, mortgage companies, lending institutions and title insurers to facilitate remote video-conferencing of potential buyers and sellers with independent escrow agents. The design includes contracting with and/or contacting at least one escrow company to provide escrow services from a remote location; contracting with and/or contacting at least one non-escrow company, e.g., broker, mortgage company, lending institution, and/or title insurer, to allow remote escrow services to be provided at an office of at least one non-escrow company; and enabling the provision of escrow services by the escrow company to an individual located at the office of at least one non-escrow company via a videoconferencing system disposed between the escrow company and the office of the non-escrow company.

These and other advantages of the present invention will become apparent to those skilled in the art from the following detailed description of the invention and the accompanying drawings.

### BRIEF DESCRIPTION OF THE DRAWINGS

The present invention is illustrated by way of example, and not by way of limitation, in the figures of the accompanying drawings in which:

FIG. 1 is a flow diagram showing an illustrative embodiment of the EAS franchising design;

FIG. 2 is a diagram showing a typical EAS network implemented according to the present design;

FIGS. 3a and 3b illustrate a flow diagram showing an illustrative embodiment of software running on one or more client computers and adapted to implement the EAS system;

FIG. 4 is a simplified block diagram of an illustrative implementation of a client subsystem;

FIG. 5 illustrates an alternate flowchart of the process of establishing EAS franchisees; and

FIG. 6 illustrates a general implementation of the franchising concept of the present design.

### DETAILED DESCRIPTION OF THE INVENTION

Illustrative embodiments and exemplary applications will now be described with reference to the accompanying drawings to disclose the advantageous teachings of the present invention.

While the present invention is described with reference to illustrative embodiments for particular applications, it is to be understood that the invention is not limited thereto. Those having ordinary skill in the art and access to the teachings provided herein will recognize additional modifications, applications, and embodiments within the scope thereof and additional fields in which the present invention would be of significant utility.

In accordance with the present teachings, a novel method of providing escrow services is disclosed by which escrow services are facilitated through an escrow accommodation service. As discussed more fully below, the escrow accommodation method of the present invention provides a novel arrangement which facilitates the provision of escrow services to potential buyers and sellers by independent escrow companies via remote video-conferencing systems located in the offices of non-escrow service providers such as brokers, mortgage companies, lending institutions and title insurers.

Generally, the inventive method includes contracting with at least one escrow company to provide escrow services from a remote location; contracting with one or more non-escrow companies to allow remote escrow services to be provided at an office of the one or more non-escrow companies; and enabling the provision of escrow services by the escrow company to an individual located at the office of one or more non-escrow companies via a videoconferencing system disposed between the at least one escrow company and the office of the non-escrow company.

One videoconferencing system that may be employed in the current design is known as an escrow accommodation service (EAS) system. The present design may include conferring EAS franchise status to an entity. In such a situation, the EAS franchisee makes agreements with the escrow company and the non-escrow company, wherein such agreements contemplate access to and use of the EAS system. The franchise fee may be fixed, periodic and/or based on a percentage of revenues generated by the franchisee.

Contracting with the at least one escrow company includes conferring membership status in exchange for a fee. Membership status may be conferred in any manner, including electronically via a computer system or other appropriate device or network. As an alternative, contracting with at least one escrow company may include conferring membership status in exchange for a percentage of revenue generated by the escrow company via the videoconferencing system.

The franchise aspect of the present design may be automated, wherein certain individuals are identified as potential franchisees, information regarding EAS franchising is provided to the potential franchisee, and the potential franchisee may elect to participate as a franchisee by communicating, such as via email or the internet, a desire to become a franchisee, and elect to be bound by a franchise contract. In such a situation, a server having the requisite information maintained in a database or appropriate storage medium, including established standard communications, such as franchise marketing letters and franchise agreements.

In another embodiment, contracting with one or more non-escrow companies includes conferring membership status in exchange for a fee. Contracting with one or more non-escrow companies may include conferring membership status in exchange for a percentage of revenues generated by the non-escrow company via the videoconferencing system.

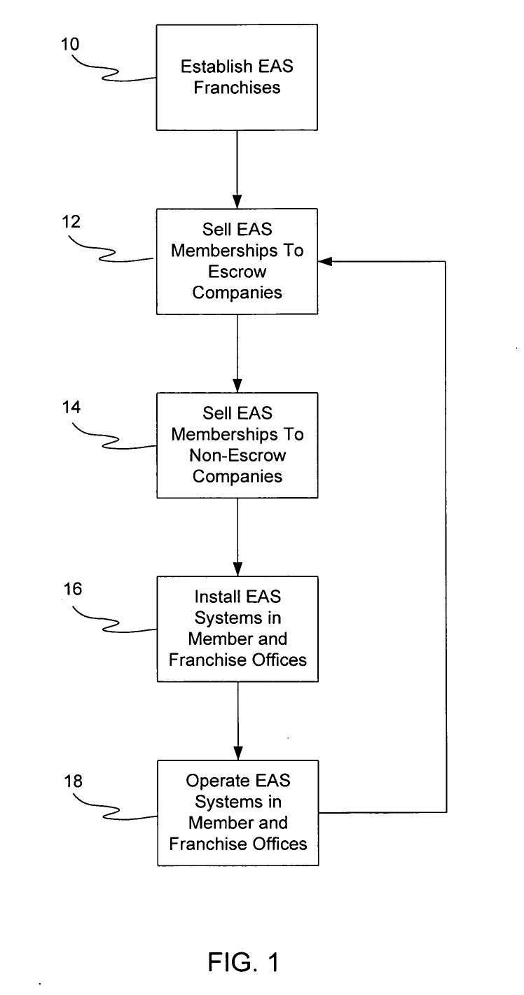

FIG. 1 is a flow diagram showing one illustrative embodiment of the escrow accommodation method. The method illustrated in FIG. 1 begins at point 10 with selling or establishing EAS franchises, either using devices such as telephones or an automated system, such as a server configured to sell such franchises. Franchises may be sold by an EAS franchisor to a number of qualified franchises. Each franchise may be limited in some form, such as geographically.

Next, at point 12, the franchisee may sell or otherwise convey EAS memberships to escrow companies. In one embodiment, in exchange for EAS membership, the escrow companies receive the right and the equipment from an EAS franchisee to provide remote escrow services via the EAS videoconferencing system in exchange for a fee. The fee may be paid on a monthly, bi-monthly, annual, semi-annual or any other regular basis or, as an alternative, may be paid based on a percentage of revenues generated by the escrow company by providing escrow services via the EAS system and method or any combination of the above.

Next, at point 14, the franchisee may sell memberships to non-escrow companies, again using an automated or non-automated design, including over a computer network. For the purpose of this disclosure, the term “non-escrow” refers to those companies that are not primarily and regularly engaged in the business of providing escrow services and includes by way of example and without limitation brokers, mortgage companies, lending institutions and title insurers. In one embodiment in accordance with the present teachings, in exchange for EAS membership, the non-escrow companies receive the right and the equipment from an EAS franchisee to facilitate remote escrow services via the EAS videoconferencing system in exchange for a fee. The fee may be paid on a monthly, bi-monthly, annual, semi-annual or any other regular basis or, as an alternative, may be paid based on a percentage of revenues generated by the company for facilitating escrow services via the EAS system and method or any combination of the above.

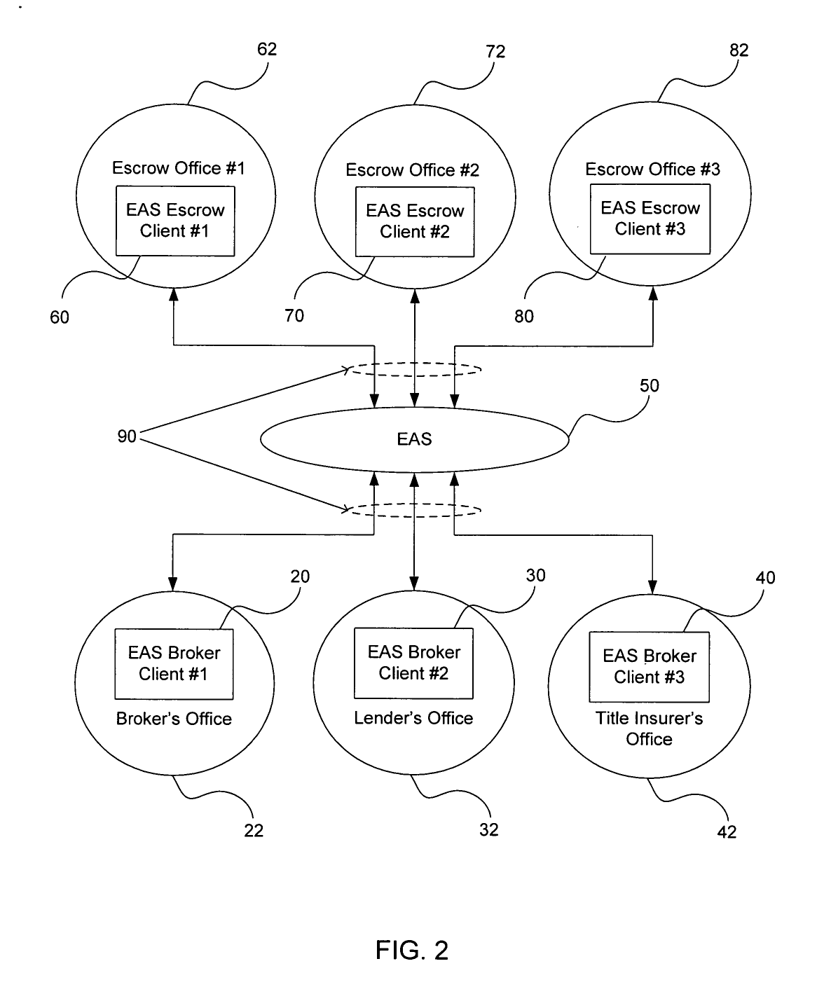

At points 16 and 18, the franchisee installs and operates EAS videoconferencing systems in each of the member offices respectively. The videoconferencing systems may be implemented, for example, as recited in accordance with the teachings disclosed in co-pending U.S. patent application Ser. No. 09/916,927, filed Jul. 27, 2001 by Ruben Duran and entitled ESCROW ACCOMMODATION SYSTEM, the teachings of which are incorporated herein by reference. A typical resulting EAS network is depicted in FIG. 2.

FIG. 2 is a diagram showing a typical EAS network. First, second and third EAS broker clients 20, 30, and 40 are located in a broker's office 22, a lender's office 32 and a title insurer's office 42 for the purpose of illustration. These offices are connected to through an EAS server 50 located in an office of an EAS franchisee via a network connection 90. The network connection 90 may be an intranet connection, extranet connection, VPN connection, or other appropriate connection, secured or unsecured. The network may be implemented via the Internet as a Virtual Private Network (VPN) or other type of electronic network appropriate to execute the functionality recited herein. The network 90 facilitates connection of the first, second and third EAS broker clients 20, 30, and 40 to first, second and third EAS escrow clients 60, 70, and 80 located in first, second and third escrow offices 62, 72, and 82 respectively.

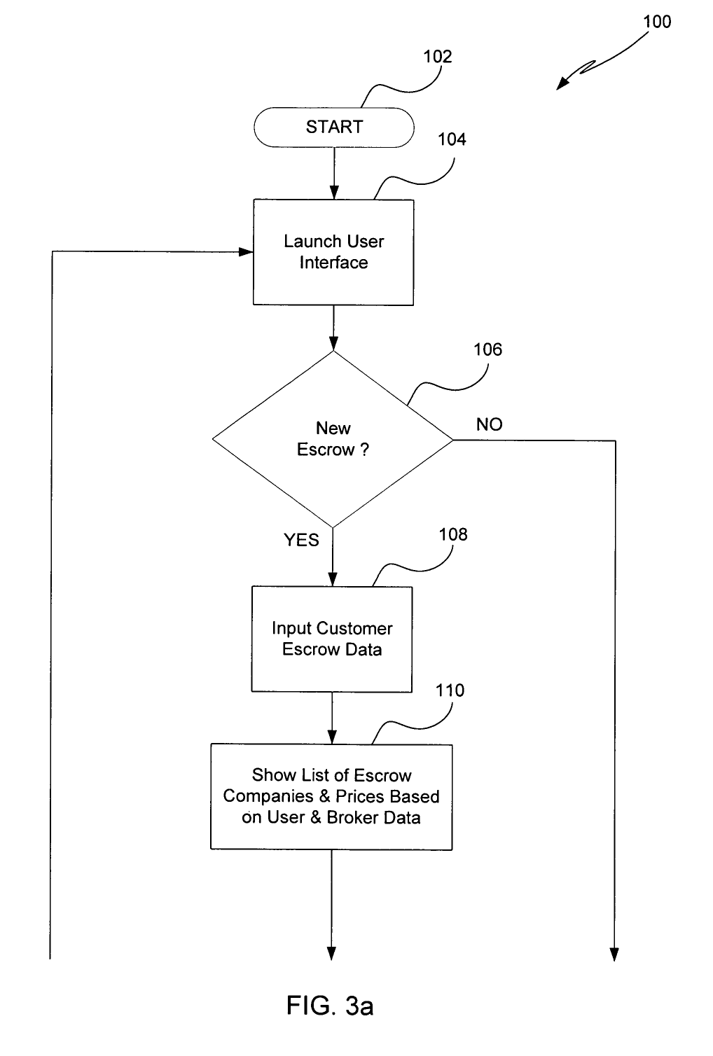

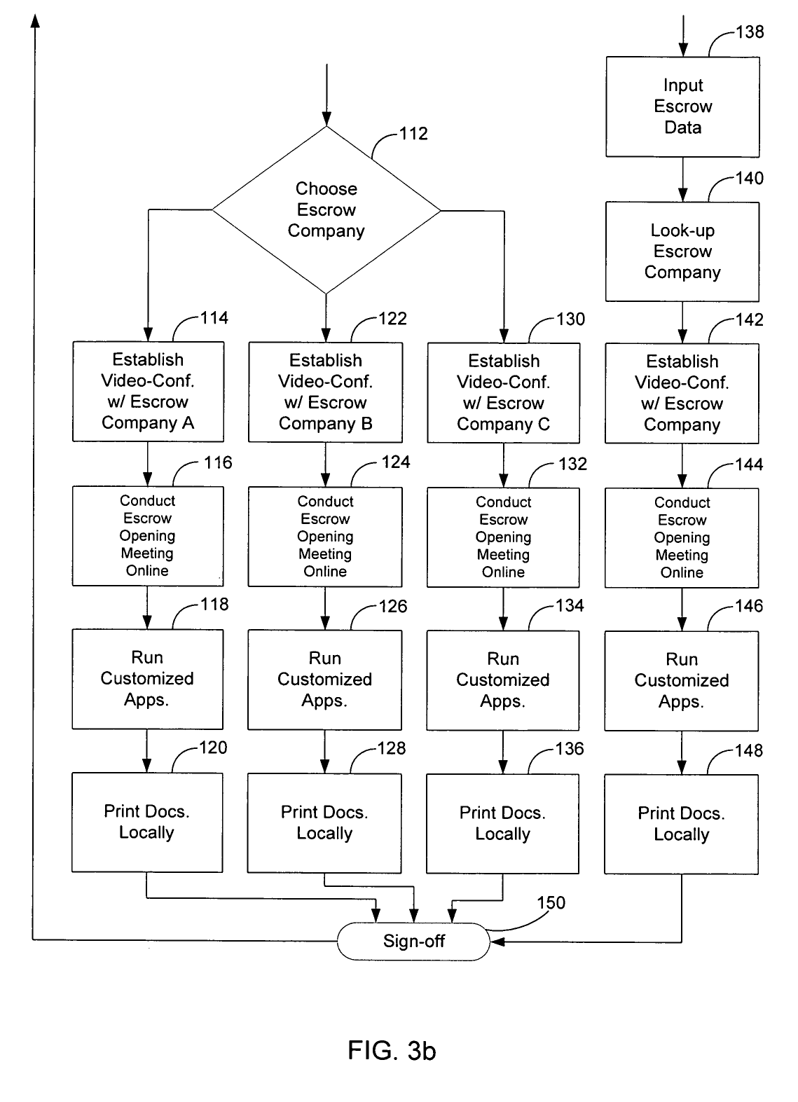

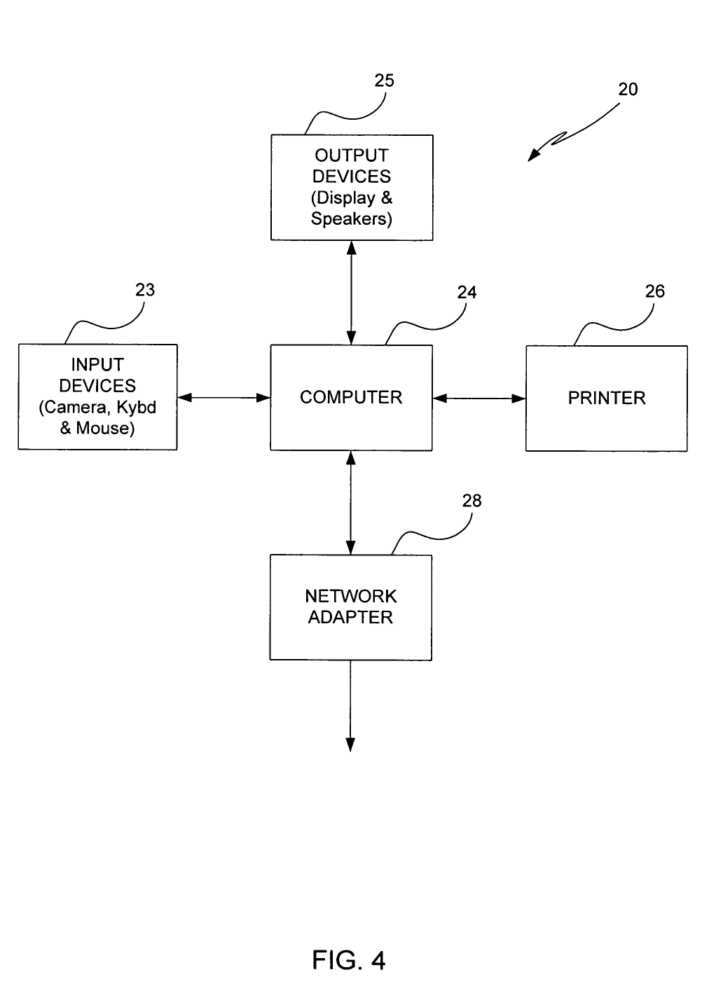

The present invention is not limited to a specific number of broker clients and/or escrow clients installed, or to particular types of offices within which the systems are installed. The operation of each client system is described more fully below with reference to FIGS. 3 and 4.

FIGS. 3a and 3b represent a flow diagram showing an illustrative embodiment of software running on the client computers aid adapted to implement the EAS system. The software 100 is adapted to maintain a standby state at point 102 until initiated by user, such as via a keystroke or movement of a mouse. At point 104, the software launches a user interface which, at point 106, prompts the user to indicate whether the user is seeking to implement or change an existing escrow or establish a new escrow arrangement. If the user seeks to establish a new escrow arrangement, then at point 108 the user inputs customer escrow data using one of a number of commercially available escrow software packages such as Simon and Escrowlink.

The software 100 on the system responds by displaying a list of escrow companies along with price, address, phone number and other relevant information at point 110. In accordance with the present teachings, this list is customized based on the relationships between the brokers and the escrow agents, user data, broker data and any other relevant considerations.

At point 112, the user selects an escrow company and at point 114, 122, or 130, the system establishes a videoconference with the selected escrow company. Assuming Company A is selected, then at point 116, an escrow opening meeting is conducted online in videoconferencing mode. At this point, the escrow officer may ask the prospective buyer or seller a variety of questions relating to the escrow arrangement. During this process, one or more software applications, customized for the escrow company, may run. The application processes data input from the prospective buyer or seller at point 108 and provides documents to the buyer or seller locally via a printer 26.

Points 122 through 128 and points 130 through 136 are shown as being substantially identical to points 114 through 120. In practice, the steps may be customized for the requirements and preferences of the escrow company, the broker, and/or the user without departing from the scope of the present teachings.

If at point 106, the user, i.e., the prospective buyer or seller, indicates a willingness To work on an existing escrow, then at point 138 escrow data is input such as an escrow number and the system 100 looks up the escrow agreement and the appropriate escrow Company at point 140. The system in executes points 142 through 148 in a similar or identical manner as points 114 through 120 in this embodiment, but other functionality enhancing the escrow process or experience may be employed.

At point 150 the user may sign off and the system may return to standby mode at point 104. The software 100 may be implemented in C, C++, JAVA, Visual Basic or 10 any other suitable conventional programming language by one of ordinary skill in the art without undue experimentation.

FIG. 4 is a simplified block diagram of an illustrative implementation of a client subsystem in accordance with the teachings of the present invention. As each of the clients may be implemented in substantially the same manner, only the first broker client 20 is illustrated in FIG. 4. In accordance with the present teachings, each client is equipped with a computer 24 within which a general-purpose microprocessor (not shown) is disposed. The computer 24 receives input from a plurality of input devices 23 including but not limited to a camera, keyboard and mouse. The camera 23 provides an image of the user to a receiving client (escrow officer) via the computer 24, a network adapter 28, the server 50, and the network 90 as discussed above. In accordance with the present teachings, an image or voice of an independent escrow agent is received by the client 20 via the network 90, network adapter 28, and the computer 24 and displayed on a multimedia screen 25. The screen 25 may be a large flat-panel display. The EAS system 10 is typically controlled by software running on the computer 24. Further, those skilled in the art will appreciate that conventional software may be implemented on the server 50 to facilitate the routing of videoconferencing calls in accordance with I-ITTP, FTP TCPIIP, NETBUI, IPX SPX, or other suitable protocols.

As result of membership in an EAS franchise operation, the brokerage company may no longer have the responsibilities or liabilities of a broker owned Escrow Company such as brokers license liability, DRF audits, employee liability, medical insurance, wages, and office expenditures such as telephones, paper, computers, copier expenses, and so forth. In addition, space normally utilized for escrow purposes can be used for different purposes such as additional real estate agents or rental income. The brokerage still has the option of providing customer service in the escrow area by allowing the EAS franchisee to install technology in an area of the real estate company. Such an installation or capability may enable brokers to have direct immediate access to a variety of escrow companies through the technology provided by the service company which includes teleconferencing technology that allows instant face to face communication and live interaction with multi-language selection. Further technology is provided for immediate viewing and printing of contracts. Deposit containers may be provided for daily pickup of money or original documents needed to be forwarded to escrow. All other copied documents may be transmitted electronically or via facsimile which may also be provided as part of the EAS system. In short, and EAS member broker may expect that as result of being able to offer remote escrow service capabilities, the broker may see greater volume particularly with respect to walk-in's and refinances and be able to offer more flexibility with respect to escrow officer selection and multilingual support.

In addition, in accordance with the present teachings, a listing broker office ‘a’ might be the listing agent, i.e. the agent listing the property, and an EAS member along with a selling broker “b”. Both offices may receive credit for 50% if any escrow company that is used is also an EAS Member. Such an arrangement may eliminate some of the competition and adversity that is presently caused by broker owned escrows. A broker will now look forward to getting paid on all escrows without having to control the destination as long as everyone is affiliated. In addition, the selection and accessibility of various escrow companies available through and EAS Franchise makes it difficult to accuse anyone of misdirecting business or clients.

The EAS member escrow companies may see a larger client base or market, larger trust accounts, lower operational costs per escrow, and ease of consolidation of escrow offices. EAS member title companies may be able to approach broker owned escrow companies through actual real estate brokers who are presently their clients or will be their new customers if they join or participate.

This new business approach allows title companies not only to solicit titles but also escrows using their present title representative work force. If a title representative is successful in soliciting titles in a certain office or area his ability to originate escrow business may also see increased success and may compare favorably with title production.

In short, EAS membership may relieve a real estate brokerage of certain risk associated with broker escrow services and return market share back to the escrow industry while allowing escrow companies and brokerage firms to reap the 25 income benefits there from.

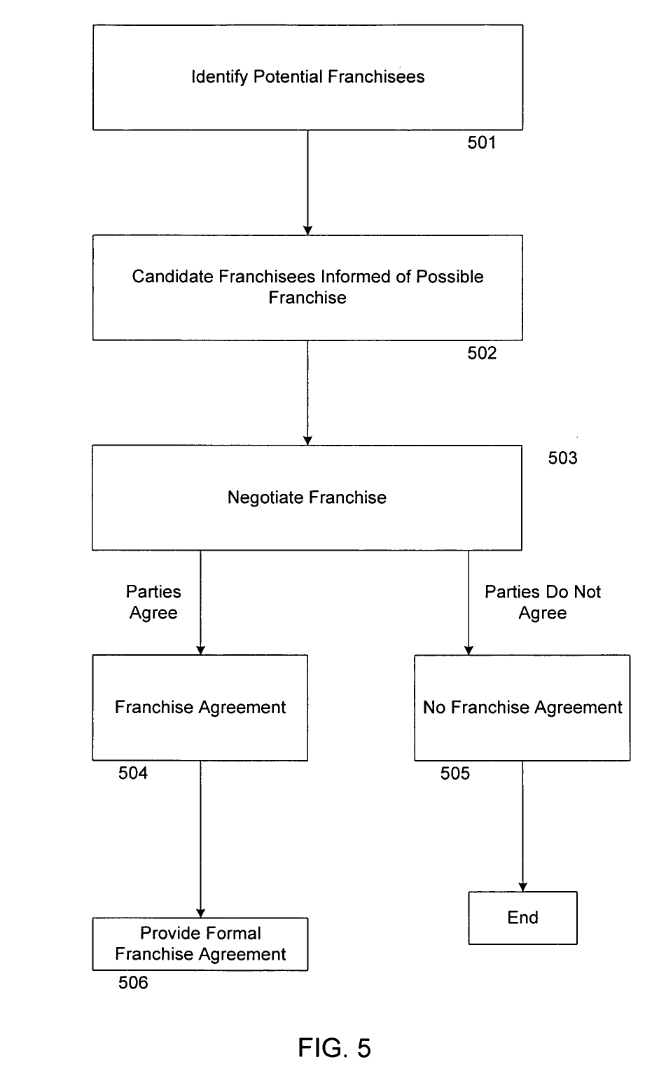

FIG. 5 illustrates operation according to the present method. At point 501, potential franchisees are identified, either by persons establishing such potential franchisees, or by automated manner, such as searching for third party prospects from databases, phone records, and so forth. As an example, certain jurisdictions do not employ escrow; in such a situation, records or databases for applicable jurisdictions may be performed by a computing device or other appropriate methodology. At point 502, candidate franchisees are informed of the possible EAS franchise and interest in such a franchise is considered. Such informing may occur by letter, email, or by communication via server, or by advertising (automated or otherwise), or any means known in the art.

Point 503 illustrates negotiation of the EAS franchise, which may be minimal, such as the potential franchisee indicating a desire to become a franchisee, or may be more involved, including face-to-face meetings, correspondence, email, demonstrations, evaluations of the EAS system, and so forth. The two possible outcomes of point 503 is franchise agreement, shown at point 504, or no franchise agreement, wherein the process terminates, shown at point 505. Point 506 represents providing a franchise agreement to the potential franchisee, which can be accepted or rejected. If accepted, the franchise is established according to the agreement; if rejected, a counter-offer may be made, or specific issues with the agreement identified. Again, the agreement is either consummated or not, and if not consummated, additional discussions or correspondence may occur.

Point 506 may be implemented by the EAS franchisor providing a formal agreement to the potential franchisee, such as in the form of a written contract including applicable provisions. Standard agreements may be available and transmitted, such as obtaining an appropriate agreement from a database (appropriate for the jurisdiction, conditions of franchise including payment terms, operation requirements, and so forth), and electronically transmitting the agreement to the potential franchisee. Materials may be conveyed by other conventional means, and agreements may be drawn up using standard boilerplate agreements or special agreements based on circumstances.

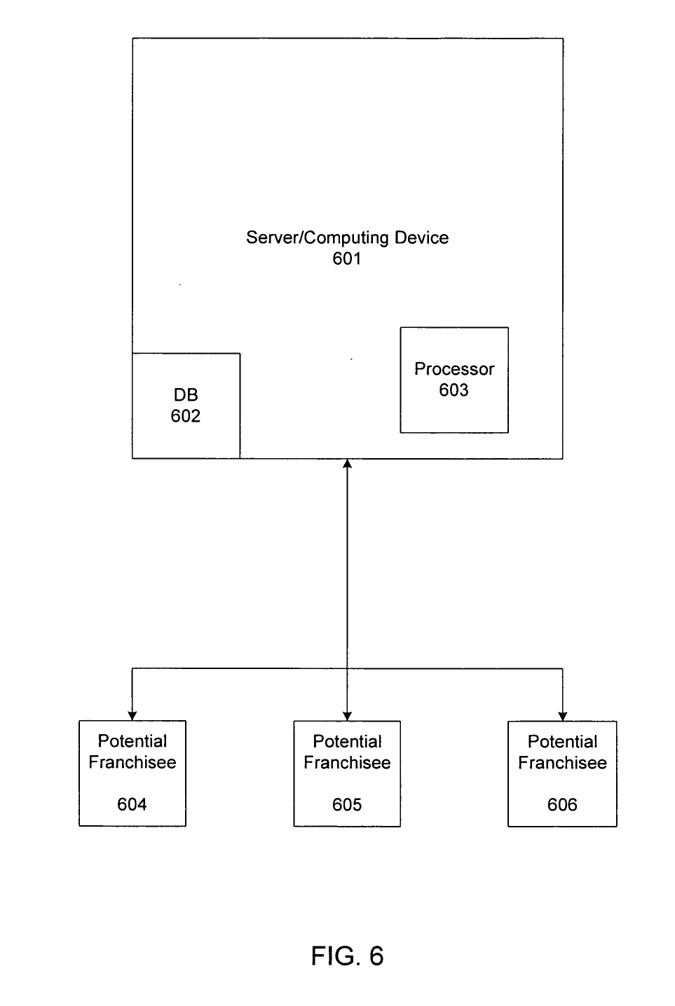

The result is a system that may be implemented using a client-server arrangement on a standard network, including over the Internet. A server, such as is shown in FIG. 6, may obtain leads/potential franchisees by searching available databases, may solicit membership or franchise opportunities by automated solicitation, and may provide standard or even specialized franchise agreements using electronic communication. The result is an automated franchising arrangement that establishes EAS franchises, with setting up the EAS system as a follow-up to the design of FIG. 5. Alternately, certain of the processes and functions of FIG. 5 may be performed by individuals. However, the present design may be entirely automated according to FIG. 5, with a follow up setup of EAS stations or sites at franchise escrow company or non-escrow company offices, on a general purpose or special purpose computing device or network.

FIG. 6 illustrates a general implementation of the franchising concept of the present design. From FIG. 6, server 601 is shown representing a central computer processing device having access to database 602 and employing processor 603. Additional components, such as storage media, may be employed, and the system may include devices other than servers, such as a personal computer, workstation, or other device. While a single server is shown as server 601, it is to be understood that the functionality disclosed herein may be performed on or across multiple devices. Further, while the processor 603 and database 602 are shown as within server 601, it is to be understood that such components may be outside or separate from the other components while still performing the functionality disclosed herein, and different permutations are possible, such as the database 602 residing on storage media (not shown).

In operation, once at least one potential franchisee has been identified, including by the server 601 or similar device potentially by a search of database 602, the system in the form of server 601 in this embodiment may communicate with the potential franchisee or franchisees. Potential franchisees 604, 605, and 606 are shown, but any number of potential franchisees may be communicated with at any time, and communication may be sporadic, such as sending an email one day to potential franchisee 605 and waiting for weeks before sending a follow up to potential franchisee 605. Note also that certain internal functions may occur, such as internal reminders, suggestions to call or contact potential franchisees offline, and statistics may be generated.

Once the potential franchisee indicates an interest in obtaining a franchise, the system may obtain an appropriate sample agreement from database 602 and provide the sample agreement to the potential franchisee, for example potential franchisee 606. Alternately, a suggested term sheet or other negotiation documentation may be created or obtained and provided to the potential franchisee 606. If the potential franchisee accepts the terms or agreement, he may provide an indication of such approval to the server or the entity maintaining the server and the franchise arrangement consummated.

Other components may be included, such as a connection to an agent or employee or other individual who monitors the system, and may offer negotiation information, such as an email to the server for transmission to the potential franchisee, or contract terms, or may simply monitor statistics. Again, multiple servers or other computing devices may be employed, multiple potential franchisees contacted, and multiple separate components not shown provided, such as employee workstations, storage media, and so forth. The potential franchisee and server 601 may include functionality executable on various devices, including but not limited to cellphones, smart phones, tablet devices, and other appropriate devices.

While the present design has been shown as a franchise, it is to be understood that any business entity may be operated in this manner; subsidiary, joint venture, partnership, or otherwise, based on circumstances.

The design presented herein and the specific aspects illustrated are meant not to be limiting, but may include alternate components while still incorporating the teachings and benefits of the invention. While the invention has thus been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

1. An escrow accommodation method configured to be performed using a computing device comprising a videoconferencing system, comprising:
contracting with at least one escrow company to provide escrow services from a remote location via the videoconferencing system;
contracting with at least one non-escrow company to allow remote escrow services to be provided via the videoconferencing system at an office of one non-escrow company, wherein the one non-escrow company is a company not configured to regularly provide escrow services; and
enabling, using the computing device, provision of escrow services by the escrow company to an individual located at said office of the one non-escrow company via the videoconferencing system disposed between one escrow company and the one non-escrow company, wherein the computing device is configured to run customized escrow applications customized for the one non-escrow company based on input received from at least one of an escrow agent, a customer, a broker, and a third party;
wherein the videoconferencing system is configured to display a list of available escrow companies for performing escrow services and fees associated with available escrow companies, the list of available escrow companies customizable based on at least one of customer data and broker data, and the videoconferencing system is further configured to facilitate an escrow opening meeting online between the individual and the escrow company when selected by the individual from the list of available escrow companies.

2. The escrow accommodation method of claim 1 wherein contracting with said one escrow company includes conferring membership status in exchange for a fee.

3. The escrow accommodation method of claim 1 wherein contracting with the one escrow company includes conferring membership status in exchange for a percentage of revenue generated by the escrow company via said videoconferencing system.

4. The escrow accommodation method of claim 1 wherein contracting with the one non-escrow company includes conferring membership status in exchange for a fee.

5. The escrow accommodation method of claim 1 wherein contracting with the one non-escrow company includes conferring membership status in exchange for a percentage of revenues generated by the non-escrow company via the videoconferencing system.

6. The escrow accommodation method of claim 1 further comprising conferring Escrow Accommodation System (EAS) Franchisee status to an entity.

7. The escrow accommodation method of claim 6 wherein the contracts with the escrow company and the non-escrow company are made with an EAS franchisee.

8. The escrow accommodation method of claim 7 further comprising conferring EAS franchisee status to an entity in exchange for a fee.

9. The escrow accommodation method of claim 8 wherein the EAS franchisee fee is based on a percentage of revenues generated by contracts with the escrow company and the non-escrow company.

10. The escrow accommodation method of claim 1 wherein the videoconferencing system is an Escrow Accommodation System.

11. An escrow accommodation device comprising:
means for contacting at least one escrow company to suggest providing escrow services from a remote location via a videoconferencing system;
means for contacting a non-escrow company to suggest allowing remote escrow services to be provided at an office of the non-escrow company via the videoconferencing system, wherein the non-escrow company is a company not configured to regularly provide escrow services; and
means for establishing for the provision of escrow services by the escrow company to an individual located at said office of the non-escrow company via the videoconferencing system disposed between one escrow company and the non-escrow company, wherein the means for establishing for the provision of escrow services comprise a computing device configured to run customized escrow applications customized for the non-escrow company based on input received from at least one of an escrow agent, a customer, a broker, and a third party;
wherein the videoconferencing system is configured to display a list of available escrow companies for performing escrow services and fees associated with available escrow companies, the list of available escrow companies customizable based on at least one of customer data and broker data, and the videoconferencing system is further configured to facilitate an escrow opening meeting online between the individual and the escrow company when selected by the individual from the list of available escrow companies.

12. An escrow accommodation system, comprising:
a central server configured to communicate with a videoconferencing arrangement, the videoconferencing arrangement comprising:
an escrow company videoconferencing station established at a contracted escrow company location;
a non-escrow company videoconferencing station established at a contracted non-escrow company location, wherein the non-escrow company videoconferencing station comprises a computing device configured to run customized escrow applications customized for one non-escrow company based on input received from at least one of an escrow agent, a customer, a broker, a third party;
wherein the non-escrow company videoconferencing station is configured to display a list of available escrow companies for performing escrow services and fees associated with available escrow companies, the list of available escrow companies customizable based on at least one of customer data and broker data, and the non-escrow company videoconferencing station is further configured to facilitate an escrow opening meeting online between an individual and an escrow company when selected by the individual from the list of available escrow companies.

13. The escrow accommodation device of claim 11 wherein the means for contracting with said escrow company include means for conferring membership status in exchange for a fee.

14. The escrow accommodation device of claim 11 wherein the means for contracting with said escrow company include means for conferring membership status in exchange for a percentage of revenue generated by the escrow company via said videoconferencing system.

15. The escrow accommodation device of claim 11 wherein the means for contracting with the non-escrow company includes means for conferring membership status in exchange for a fee.

16. The escrow accommodation device of claim 11 wherein the means for contracting with the non-escrow company includes means for conferring membership status in exchange for a percentage of revenues generated by the non-escrow company via the videoconferencing system.

17. The escrow accommodation device of claim 11 further comprising means for conferring EAS (Escrow Accommodation System) Franchisee status to an entity.

18. The escrow accommodation device of claim 17 wherein the contracts with the escrow company and the non-escrow company are made with an EAS franchisee.

19. The escrow accommodation device of claim 18 further comprising means for conferring EAS franchisee status to an entity in exchange for a fee.

20. The escrow accommodation device of claim 19 wherein the EAS franchisee fee is based on a percentage of revenues generated by contracts with the escrow company and the non-escrow company.
